(19) United States
(12) Patent Application Publication
(10) Pub. No.: US 2018/0284970 A1
(43) Pub. Date: Oct. 4, 2018

(54) MOBILE ELECTRONIC DEVICE, CONTROL METHOD, AND CONTROL MEDIUM

(71) Applicant: KYOCERA Corporation, Kyoto-shi (JP)

(72) Inventors: Tomohiro SUDO, Yokohama-shi (JP); Toshiaki NADE, Yokohama-shi (JP); Shingo ITO, Yokohama-shi (JP)

(21) Appl. No.: 15/938,030

(22) Filed: Mar. 28, 2018

(30) Foreign Application Priority Data
Mar. 29, 2017 (JP) 2017-065779

(51) Int. Cl. G06F 3/0481; G02F 1/1333; G02F 1/1335

(52) U.S. Cl. CPC G06F 3/04817; G02F 1/133602; G02F 1/13338

(57) ABSTRACT

Provided is a mobile electronic device, comprising a first display, a second display that overlaps with the first display and configured to be switched between a transmissive state that passes incident light and a reflective state that reflects incident light, and a controller configured to control display of a first screen for the first display and a second screen for the second display, wherein the controller switches at least part of the second display to the transmissive state to cause the first display to display the first screen, and causes the second display to display the second screen in accordance with a condition.

### CROSS-REFERENCE TO RELATED APPLICATION

The present application claims priority under 35 U.S.C. § 119 to Japanese Patent Application No. 2017-065779, filed on Mar. 29, 2017, entitled “MOBILE ELECTRONIC DEVICE, CONTROL METHOD, AND CONTROL PROGRAM,” the content of which is incorporated by reference herein in its entirety.

### FIELD

The present disclosure relates to a mobile electronic device, a control method, and a control medium.

### BACKGROUND

Mobile electronic devices having a transmissive display are known. Such a mobile electronic device includes a light source such as a backlight to enable a transmissive display to be visually recognized.

### SUMMARY

A mobile electronic device according to one embodiment includes a first display, a second display that overlaps with the first display and configured to be switched between a transmissive state that passes incident light and a reflective state that reflects incident light, and a controller configured to control display of a first screen for the first display and a second screen for the second display. The controller switches at least part of the second display to the transmissive state to cause the first display to display the first screen, and causes the second display to display the second screen in accordance with a condition.

A control method according to one embodiment executed by a mobile electronic device that comprises a first display and a second display that overlaps with the first display and configured to be switched between a transmissive state that passes incident light and a reflective state that reflects incident light, includes steps of switching at least part of the second display to the transmissive state to cause the first display to display a first screen for the first display, and causing the second display to display a second screen for the second display in accordance with a condition.

A non-transitory computer readable recording medium storing therein a control program according to one embodiment causes a mobile electronic device that comprises a first display and a second display that overlaps with the first display and configured to be switched between a transmissive state that passes incident light and a reflective state that reflects incident light to execute steps of switching at least part of the second display to the transmissive state to cause the first display to display a first screen for the first display, and causing the second display to display a second screen for the second display in accordance with a condition.

### BRIEF DESCRIPTION OF THE DRAWINGS

FIG. 1 is a front elevational view of an example of a smartphone according to embodiments;

FIG. 2 is a diagram of an example of an arrangement of displays of the smartphone according to embodiments;

FIG. 3 is a diagram of an example of a state of a second display according to embodiments;

FIG. 4 is a diagram of an example of display areas of a first display and the second display according to embodiments;

FIG. 5 is a block diagram of the smartphone according to embodiments;

FIG. 6 is a diagram of an example of a first screen and a second screen according to embodiments;

FIG. 7 is a flowchart of an exemplary processing procedure of display control by the smartphone according to embodiments;

FIG. 8 is a flowchart of another exemplary processing procedure of the display control by the smartphone according to embodiments;

FIG. 9 is a diagram of an example of editing control on the first screen and the second screen by the smartphone according to embodiments;

FIG. 10 is a flowchart of an exemplary processing procedure of the display control by the smartphone according to embodiments;

FIG. 11 is a diagram of another example of the editing control on the first screen and the second screen by the smartphone according to embodiments;

FIG. 12 is a flowchart of another exemplary processing procedure of the display control by the smartphone according to embodiments;

FIG. 13 is a diagram of an example of display control on a third screen and a fourth screen by the smartphone according to embodiments; and

FIG. 14 is a flowchart of another exemplary processing procedure of the display control by the smartphone according to embodiments.

### DETAILED DESCRIPTION

The following describes a plurality of embodiments for implementing a mobile electronic device, a control method, and a control program according to the present application in detail with reference to the accompanying drawings. The following describes a smartphone as an example of the mobile electronic device.

### Embodiments

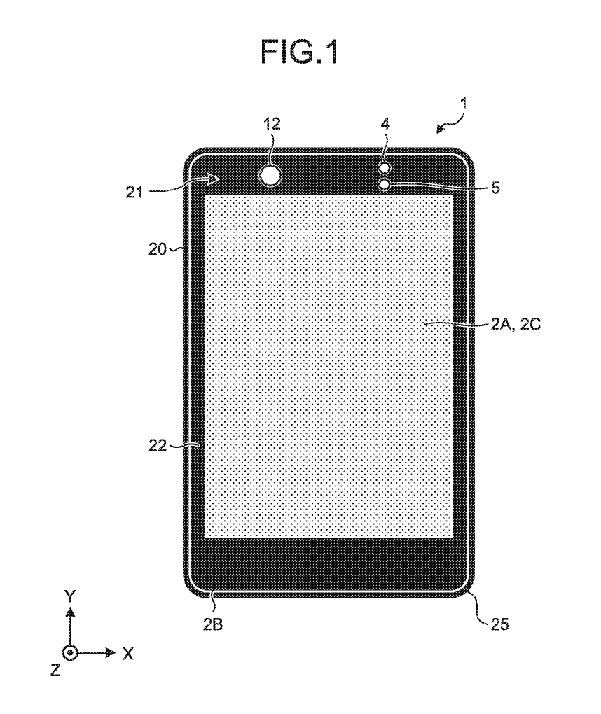

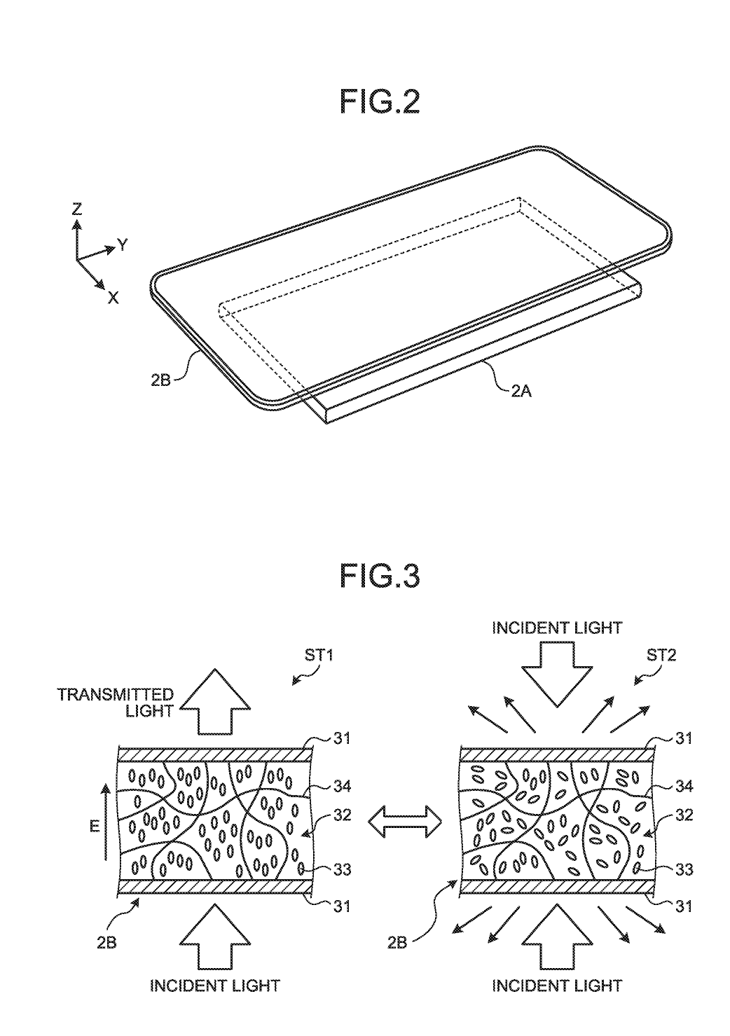

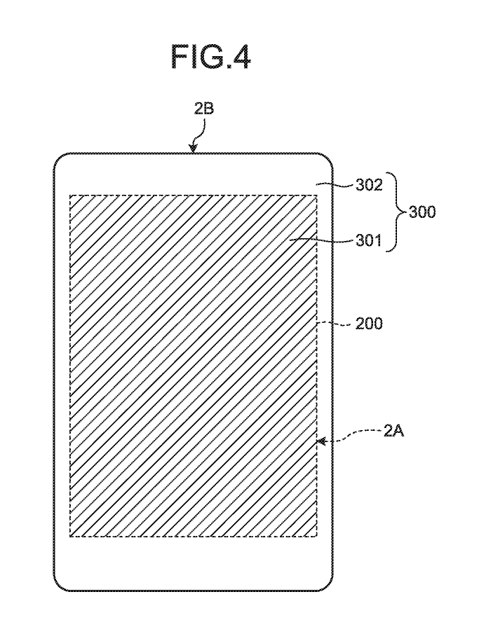

Conventional mobile electronic devices may have a room for improvement in a technique that diversifies displaying of a display. The following describes an overall configuration of a smartphone 1 according to embodiments with reference to FIG. 1 to FIG. 4. FIG. 1 is a front elevational view of an example of the smartphone 1 according to embodiments. FIG. 2 is a diagram of an example of an arrangement of displays of the smartphone 1 according to embodiments. FIG. 3 is a diagram of an example of a state of a second display according to embodiments.

As illustrated in FIG. 1, the smartphone 1 has a housing 20. The housing 20 has a principal face 21. The principal face 21 is a front face (a display face) of the smartphone 1. The smartphone 1 has a first display 2A, a second display 2B, a touch screen 2C, an illuminance sensor 4, a proximity sensor 5, and a camera 12 on the principal face 21.

The first display 2A and the touch screen 2C have a substantially rectangular shape along the periphery of the principal face 21. The first display 2A and the touch screen 2C are surrounded by a front panel 22 of the housing 20 on the principal face 21. Although the first display 2A and the touch screen 2C each have a substantially rectangular shape, the shape of the first display 2A and the touch screen 2C is not limited thereto. The first display 2A and the touch screen 2C can each have any shape such as a square or circle. Although the first display 2A and the touch screen 2C are positioned in an overlapped manner in the example in FIG. 1, the positions of the first display 2A and the touch screen 2C are not limited thereto. The first display 2A and the touch screen 2C may be positioned side by side or positioned apart from each other, for example. Although the long side of the first display 2A is along the long side of the touch screen 2C, whereas the short side of the first display 2A is along the short side of the touch screen 2C in the example in FIG. 1, the manner of overlapping the first display 2A and the touch screen 2C with each other is not limited thereto. When the first display 2A and the touch screen 2C are positioned in an overlapped manner, one or a plurality of sides of the first display 2A are not necessarily along any side of the touch screen 2C, for example.

The first display 2A includes a display device such as a liquid crystal display (LCD), an organic electro-luminescence display (OELD), or an inorganic electro-luminescence display (IELD). The first display 2A includes a transmissive display and a self-luminous display. Embodiments describe a case in which the first display 2A is a liquid crystal display having a backlight.

The second display 2B has a shape similar to that of the principal face 21 of the housing 20. The second display 2B has a shape larger than that of the first display 2A. The second display 2B overlaps with the entire surface of the first display 2A and the front panel 22 of the housing 20. The entire surface of the second display 2B is covered with tempered glass 25. The second display 2B is interposed between the first display 2A and the tempered glass 25. The second display 2B may be glued between the first display 2A and the tempered glass 25 with a photocurable resin, an adhesive, and the like, for example.

The second display 2B includes a polymer network liquid crystal (PNLC) and electronic paper. Embodiments describe a case in which the second display 2B is a polymer network liquid crystal display.

As illustrated in FIG. 3, the second display 2B has substrates 31 of glass or transparent film (formed of an organic material, for example) and a liquid crystal layer 32. The second display 2B has a transmissive state ST1 that passes incident light and a reflective state ST2 that reflects incident light.

The transmissive state ST1 is a state in which voltage is applied to the substrates 31 of the second display 2B. In the transmissive state ST1, liquid crystal molecules 33 align in an electric field direction E caused by the application of voltage, and the second display 2B is transparent. In the transmissive state ST1, the second display 2B passes incident light. In the transmissive state ST1, the second display 2B emits incident light from the outside of the substrate 31 as transmitted light from the substrate 31 on the opposite side. In the transmissive state ST1, the incident light is not scattered, and the second display 2B exhibits transparency. In the transmissive state ST1, the second display 2B enables a user to visually recognize the first display 2A, the front panel 22, and the like on the back thereof. The transmissive state ST1 includes a state that enables the user to visually recognize the back of the second display 2B via the second display 2B. The transmissive state ST1 may include a semi-transparent state.

The reflective state ST2 is a state in which no voltage is applied to the substrates 31 of the second display 2B. In the reflective state ST2, the second display 2B induces a state in which the arrangement of the liquid crystal molecules 33 is nonuniform by the action of a reticulate polymer network 34 within the liquid crystal layer 32 to reflect and scatter light. In the reflective state ST2, the second display 2B can give rise to an opaque state by the reflection and scattering of light by the liquid crystal molecules 33. In the reflective state ST2, the second display 2B enables the user to visually recognize an opaque part of the second display 2B through the reflected and scattered light. The second display 2B can hide the first display 2A, the front panel 22, and the like on the back thereof by the opaque part of the reflective state ST2. Although the above exemplifies the case in which the second display 2B is transparent by the application of voltage, the opposite may be possible; the second display 2B is the transmissive state ST1 in the state in which no voltage is applied and is the reflective state ST2 in the state in which voltage is applied. In the following description, the second display 2B is the transmissive state ST1 in the state in which voltage is applied to the substrates 31, whereas the second display 2B is the reflective state ST2 in the state in which no voltage is applied to the substrates 31.

Although embodiments describe the case in which the second display 2B reflects and scatters light outside the smartphone 1 by the liquid crystal molecules 33 and thereby causes the user to visually recognize the part of the reflective state ST2 in a cloudy state, the embodiments are not limited thereto; a material showing a color different from white may be used for the second display 2B, for example.

FIG. 4 is a diagram of an example of display areas of the first display 2A and the second display 2B according to embodiments. As illustrated in FIG. 4, the first display 2A has a first display area 200. The first display area 200 is a display face for the first display 2A to display various kinds of information. The second display 2B has a second display area 300. The second display area 300 has a first area 301 and a second area 302. The first area 301 contains an area of the second display area 300 that overlaps with the first display area 200 of the first display 2A, for example. The second area 302 contains an area of the second display area 300 that does not overlap with the first display area 200. The second area 302 contains an area of the second display area 300 that overlaps with the front panel 22 illustrated in FIG. 1.

Although embodiments describe the case in which the second display 2B covers substantially the entire principal face 21 of the housing 20, the embodiments are not limited thereto; the second display 2B may cover only a certain range of the principal face 21 of the housing 20, for example. The certain range may be at least either upper or lower part of the first display 2A on the principal face 21, for example. The certain range may be part of the front panel 22, for example. When the smartphone 1 has an operation button or the like on the front panel 22 of the housing 20, for example, the second display 2B may be provided on the principal face 21 in such a manner as not to overlap with the operation button or the like.

The touch screen 2C detects the contact of a finger, a pen, a stylus pen, and the like with the touch screen 2C. The touch screen 2C can detect positions at which a plurality of fingers, pens, stylus pens, and the like have come into contact with the touch screen 2C. In the following description, the finger, the pen, the stylus pen, and the like that comes into contact with the touch screen 2C may be called a “contact object” or “contact body.”

The detection method of the touch screen 2C may be any method such as a capacitive method, a resistive film method, a surface acoustic wave method (or an ultrasonic method), an infrared method, an electromagnetic induction method, or a load detection method. To simplify the description, the following description assumes that the user uses fingers to touch the touch screen 2C in order to operate the smartphone 1.

The smartphone 1 determines the type of a gesture based on at least one of a contact detected by the touch screen 2C, a position at which a contact has been detected, a change in a position at which a contact has been detected, an interval during which contacts have been detected, and the number of times contacts have been detected. The gesture is an operation performed on the touch screen 2C. Examples of the gesture determined by the smartphone 1 include, but are not limited to, touching, long touching, releasing, swiping, tapping, double tapping, long tapping, dragging, flicking, pinching-in, pinching-out, etc.

The smartphone 1 performs operations in accordance with these gestures determined via the touch screen 2C. Consequently, intuitive, easy-to-use operability for the user is achieved. The operation performed by the smartphone 1 in accordance with the determined gesture may vary in accordance with a screen displayed on the first display 2A. In the following description, to simplify the description, “detecting a contact by the touch screen 2C and determining the type of the gesture to be X by the smartphone 1 based on the detected contact” may be described as “the smartphone detects X” or “a controller detects X.”

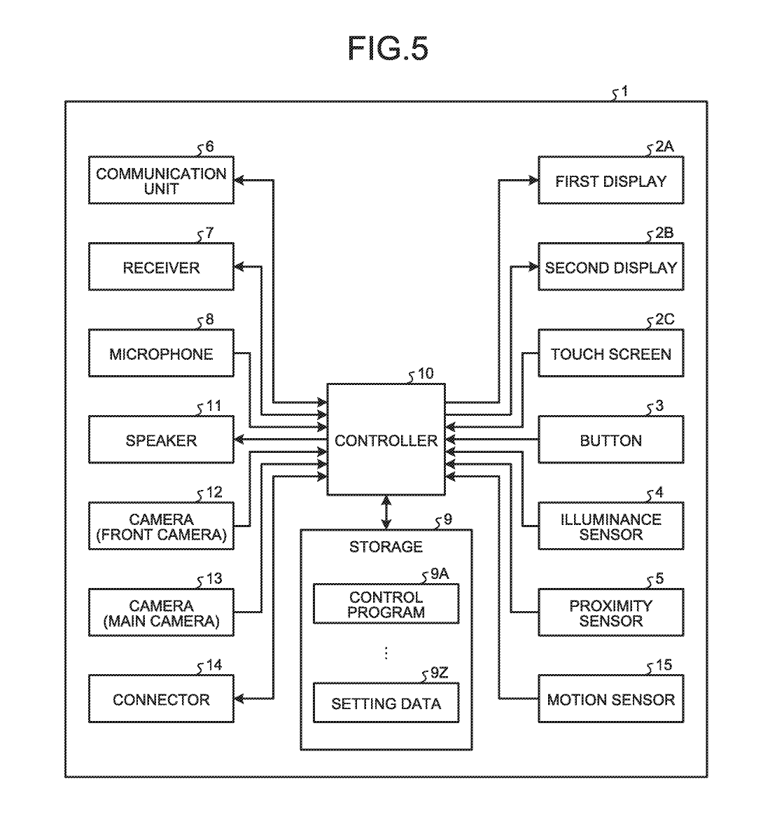

FIG. 5 is a block diagram of the smartphone 1 according to embodiments. The smartphone 1 has the first display 2A, the second display 2B, the touch screen 2C, a button 3, an illuminance sensor 4, a proximity sensor 5, a communication unit 6, a receiver 7, a microphone 8, a storage 9, a controller 10, a speaker 11, cameras 12 and 13, a connector 14, and a motion sensor 15.

The first display 2A displays characters, images, symbols, figures, and the like. The second display 2B displays characters, images, symbols, figures, and the like. The touch screen 2C detects contacts. The controller 10 detects the gesture on the smartphone 1. Specifically, the controller 10 detects the operation (gesture) on the touch screen 2C in cooperation with the touch screen 2C.

The button 3 is operated by the user. The button 3 includes a power-on/power-off button of the smartphone 1, for example. The button 3 may function also as a sleep/sleep-canceling button. The button 3 may include a volume button, for example. The controller 10 detects an operation on the button 3 in cooperation with the button 3. Examples of the operation on the button 3 include, but are not limited to, clicking, double clicking, triple clicking, pushing, multi-pushing, etc.

The illuminance sensor 4 detects the illuminance of ambient light of the smartphone 1. The illuminance is the value of a light flux incident on a unit area of a measurement face of the illuminance sensor 4. The illuminance sensor 4 is used for the adjustment of the luminance of the first display 2A, for example. The proximity sensor 5 detects the presence of a near object in a noncontact manner. The proximity sensor 5 detects the presence of an object based on a change in a magnetic field, a change in the return time of a reflected wave of an ultrasonic wave, and the like. The proximity sensor 5 detects that the first display 2A and the second display 2B have been brought close to a face, for example. The illuminance sensor 4 and the proximity sensor 5 may be configured as one sensor. The illuminance sensor 4 may also be used as a proximity sensor.

The communication unit 6 performs communication in a wireless manner. Communication methods supported by the communication unit 6 are wireless communication standards. Examples of the wireless communication standards include cellular phone communication standards such as 2G, 3G, and 4G. Examples of the cellular phone communication standards include Long Term Evolution (LTE), Wideband Code Division Multiple Access (W-CDMA), Wideband Code Division Multiple Access 2000 (CDMA 2000), Personal Digital Cellular (PDC), Global System for Mobile Communications (GSM (registered trademark)), and Personal Handy-phone System (PHS). Other examples of the wireless communication standards include Worldwide Interoperability for Microwave Access (WiMAX), IEEE 802.11, Bluetooth (registered trademark), Infrared Data Association (IrDA), and Near Field Communication (NFC). The communication unit 6 may support one or more of the communication standards described above.

The receiver 7 and the speaker 11 are examples of an output unit that outputs sounds. The receiver 7 and the speaker 11 can output sound signals transmitted from the controller 10 as sounds. The receiver 7 may be used for outputting voices of the party on the other end during a conversation, for example. The speaker 11 may be used for outputting ringtones and music, for example. One of the receiver 7 and the speaker 11 may also function as the other. The microphone 8 is an example of an input unit that inputs sounds. The microphone 8 can convert voices of the user or other audio into sound signals and transmit the sound signals to the controller 10.

The storage 9 can store therein computer programs and data. The storage 9 may be used as a work area that temporarily stores therein processing results of the controller 10. The storage 9 includes a recording medium. The recording medium may include any non-transitory storage medium such as a semiconductor storage medium and a magnetic storage medium. The storage 9 may include a plurality of kinds of storage media. The storage 9 may include a combination of a portable storage medium such as a memory card, an optical disc, or a magnetooptical disc and a reading apparatus for the storage medium. The storage 9 may include a storage device used as a temporary storage area such as a random access memory (RAM).

The computer programs stored in the storage 9 include applications executed on the foreground or background and a control program supporting the operation of the applications. The applications cause the first display 2A to display a screen and cause the controller 10 to execute processing responsive to the gesture detected via the touch screen 2C, for example. The control program is an operating system (OS), for example. The applications and the control program may be installed in the storage 9 via wireless communication by the communication unit 6 or a non-transitory storage medium.

The storage 9 stores therein a control program 9A and setting data 9Z, for example. The setting data 9Z contains information on various kinds of settings about the operation of the smartphone 1.

The control program 9A can provide functions about various kinds of control for operating the smartphone 1. The control program 9A controls the communication unit 6, the receiver 7, the microphone 8, and the like to establish a conversation, for example. The functions provided by the control program 9A include a function to perform various kinds of control such as changing information displayed on the first display 2A in accordance with the gesture detected via the touch screen 2C. The functions provided by the control program 9A include a function to control the display of the first display 2A and the second display 2B. The control program 9A provides a function to restrict reception of operations on the touch screen 2C, the button 3, and the like. The functions provided by the control program 9A include a function to detect the moving, stopping, and the like of the user who carries the smartphone 1 based on the detection result of the motion sensor 15. The functions provided by the control program 9A may be used in combination with functions provided by other computer programs.

The setting data 9Z includes condition data for determining a switching condition between a displayed state and a hidden state of the first display 2A. The displayed state includes a state in which the display of the first display 2A is enabled. The hidden state includes a state in which the display of the first display 2A is disabled and a state in which the power of the first display 2A is off. The switching condition includes a condition for performing transition of the first display 2A from the displayed state to the hidden state. The switching condition includes a condition for determining whether a certain time has elapsed from the end of an operation by the user, for example. The switching condition includes a condition for determining whether a certain time has elapsed from the time when the smartphone 1 was left to stand, for example. The condition data includes a condition for performing transition of the displayed state of the first display 2A to the hidden state. The condition data includes a condition for performing transition of the hidden state of the first display 2A to the displayed state.

The controller 10 is a processing unit. Examples of the processing unit includes, but are not limited to, a central processing unit (CPU), a system-on-chip (SoC), a micro control unit (MCU), field-programmable gate array (FPGA), a coprocessor, etc. The controller 10 can integrally control the operation of the smartphone 1. Various kinds of functions of the controller 10 are implemented based on the control of the controller 10.

Specifically, the controller 10 can execute instructions contained in the computer programs stored in the storage 9. The controller 10 can refer to the data stored in the storage 9 as needed. The controller 10 controls a functional unit in accordance with the data and the instructions. The controller 10 controls the functional unit to implement various kinds of functions. Examples of the functional unit include, but are not limited to, the first display 2A, the communication unit 6, the receiver 7, the speaker 11, etc. The controller 10 may change control in accordance with the detection result of a detector. Examples of the detector include, but are not limited to, the touch screen 2C, the button 3, the illuminance sensor 4, the proximity sensor 5, the microphone 8, the camera 12, the camera 13, the motion sensor 15, etc.

The controller 10 executes the control program 9A, for example, and can thereby execute various kinds of control such as changing information displayed on the first display 2A in accordance with the gesture detected via the touch screen 2C.

The camera 12 and the camera 13 can convert photographed images into electric signals. The camera 12 is a front camera that photographs an object facing the front panel 22. The camera 13 is a main camera that photographs an object facing a back face.

The connector 14 is a terminal to which another apparatus is connected. The connector 14 may be a universal terminal such as Universal Serial Bus (USB), High-Definition Multimedia Interface (HDMI (registered trademark)), Light Peak (Thunderbolt (registered trademark)), or an earphone/microphone connector. The connector 14 may be an exclusive terminal such as Dock connector. Examples of the apparatus connected to the connector 14 include, but are not limited to, external storages, speakers, communication apparatuses, etc.

The motion sensor 15 can detect various kinds of information for determining the motion of the user who carries the smartphone 1. The motion sensor 15 may be configured as a sensor unit including an acceleration sensor, a direction sensor, a gyroscope, a magnetic sensor, an atmospheric pressure sensor, and the like, for example.

Part or the whole of the computer programs and the data stored in the storage 9 in FIG. 5 may be downloaded from another apparatus via wireless communication by the communication unit 6. Part or the whole of the computer programs and the data stored in the storage 9 in FIG. 5 may be stored in a non-transitory storage medium that can be read by a reading apparatus included in the storage 9. Part or the whole of the computer programs and the data stored in the storage 9 in FIG. 5 may be stored in a non-transitory storage medium that can be read by a reading apparatus connected to the connector 14. Examples of the non-transitory storage medium include, but are not limited to, optical discs such as a compact disc (CD (registered trademark)), a digital versatile disc (DVD (registered trademark)), and Blu-ray (registered trademark), magnetooptical discs, magnetic storage media, memory cards, solid state storage media, etc.

The configuration of the smartphone 1 illustrated in FIG. 5 is by way of example and may be modified as appropriate to the extent that the gist of the present disclosure is not impaired. Although the smartphone 1 includes the button 3 in the example illustrated in FIG. 5, the smartphone 1 does not necessarily include the button 3. Although the smartphone 1 includes the two cameras illustrated in FIG. 5, the smartphone 1 may include only one camera or does not necessarily include any camera.

The smartphone 1 may include a GPS receiver apart from the functional units described above. The GPS receiver receives a radio wave signal of a certain frequency band from GPS satellites. The GPS receiver performs demodulation processing on the received radio wave signal and transmits the processed signal to the controller 10. The GPS receiver supports processing to compute the current position of the smartphone 1. The smartphone 1 may include a receiver that can receive signals of positioning satellites other than the GPS satellites to execute the processing to compute the current position. The smartphone 1 installs a functional unit naturally used for maintaining the functions of the smartphone 1 such as a battery and a controller naturally used for implementing the control of the smartphone 1.

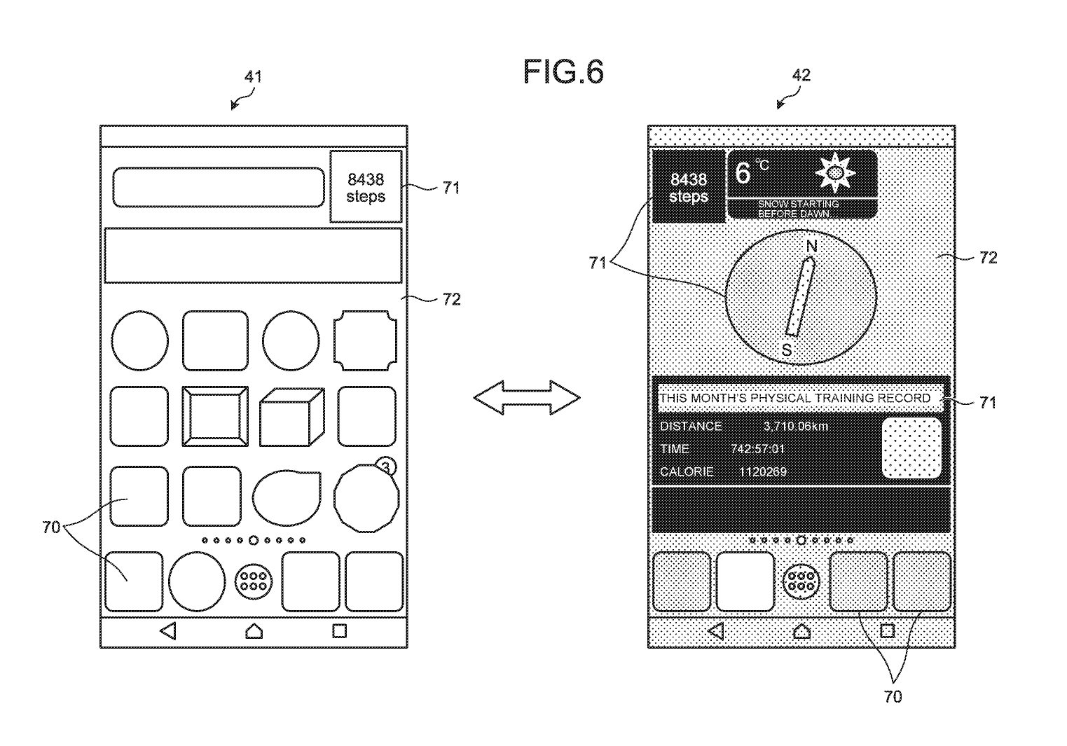

FIG. 6 is a diagram of an example of a first screen 41 and a second screen 42 according to embodiments. As illustrated in FIG. 6, the smartphone 1 can display at least either the first screen 41 or the second screen 42 in a visually recognizable manner. The first screen 41 is a home screen for the first display 2A. The first screen 41 includes a screen used in places being not bright such as indoor places and outdoor places, for example. The second screen 42 is a home screen for the second display 2B. The second screen 42 includes a screen used in bright places such as outdoor places, for example. The home screen may also be called a desktop, an idle screen, a standby screen, or a standard screen. The home screen includes a screen for causing the user to select an application to be executed among the applications installed in the smartphone 1.

The smartphone 1 displays the first screen 41 on the first display 2A with the entire second display 2B changed to the transmissive state ST1. The smartphone 1 displays data of the first screen 41 on the first display 2A. Consequently, the smartphone 1 causes the user to visually recognize the first screen 41 displayed on the first display 2A via the transparent second display 2B.

The smartphone 1 combines an area of the transmissive state ST1 and an area of the reflective state ST2 with each other in the second area 302 of the second display area 300 of the second display 2B to display the second screen 42 on the second display 2B. The smartphone 1 performs transition of the part of the second area 302 causing the user to visually recognize the part with a color on the back of the second display 2B to the transmissive state ST1, for example. The smartphone 1 performs transition of the part of the second area 302 causing the user to visually recognize the part with the color of the second display 2B such as white to the reflective state ST2, for example. The smartphone 1 displays the second screen 42 on the second display 2B to hide the first display 2A by the second screen 42. Consequently, the smartphone 1 causes the user to visually recognize the part of the transparent transmissive state ST1 of the second display 2B with the color on the back thereof. The smartphone 1 causes the user to visually recognize the part of the opaque reflective state ST2 with the color of the second display 2B. When displaying the second screen 42, the smartphone 1 displays a screen that makes the first display 2A a hidden state or a black screen, thereby enabling the user to visually recognize the part with black or other color via the second area 302 in the transmissive state ST1.

Although embodiments describe the case in which the smartphone 1 displays the second screen 42 on the second area 302 of the second display area 300 of the second display 2B to cause the first screen 41 and the second screen 42 to have the same size, the embodiments are not limited thereto; the smartphone 1 may display the second screen 42 on the entire second display area 300 to display the second screen 42 with a size larger than that of the first screen 41 on the second display 2B, for example. The smartphone 1 may display the second screen 42 with a size smaller than that of the first screen 41 on the second display 2B, for example.

The smartphone 1 can arrange icons, widgets, and the like on the first screen 41. In the example illustrated in FIG. 6, the first screen 41 arranges a plurality of icons 70 and a plurality of widgets 71. The respective icons 70 are associated with the applications installed in the smartphone 1 in advance. Upon detecting a gesture on an icon 70, the smartphone 1 executes an application associated with the icon 70 on which the gesture has been detected. Upon detecting tapping on an icon 70 associated with an e-mail application, for example, the smartphone 1 executes the e-mail application. The smartphone 1 displays information by the widgets 71.

The smartphone 1 can arrange icons, widgets, and the like on the second screen 42. In the example illustrated in FIG. 6, the second screen 42 arranges a plurality of icons 70 and a plurality of widgets 71. The second screen 42 contains the icons 70, the widgets 71, and the like of applications used by the user outdoor, for example. The first screen 41 and the second screen 42 display a wallpaper 72 behind the icons 70 and the widgets 71. The wallpaper may also be called a photo screen, a back screen, an idle image, or a background image. The smartphone 1 can use any image as the wallpaper 72. The smartphone 1 may be configured such that the user can select an image to be displayed as the wallpaper 72.

In the example illustrated in FIG. 6, the smartphone 1 displays the first screen 41 in color and displays the second screen 42 in monochrome. The smartphone 1 has widget applications about weather, direction, physical training, and the like as the applications used outdoor, for example. The smartphone 1 can cause the user to set icons, widgets, and the like to be displayed on the second screen 42. The second screen 42 may contain the icons 70 and the widgets 71 of applications used indoor.

The smartphone 1 executes the control program 9A and can thereby control display switching between the first screen 41 and the second screen 42. The smartphone 1 makes the entire second display area 300 of the second display 2B a transmissive state to cause the first display 2A to display the first screen 41. The smartphone 1 can pass light from the first display 2A through the transparent second display 2B and emit the light to the outside of the smartphone 1. Consequently, the user visually recognizes the emitted light and can thereby visually recognize a home screen 40 displayed on the first display 2A via the transparent second display 2B.

Although embodiments describe the case in which the smartphone 1 contains the icons 70 and the widgets 71 in the first screen 41 and the second screen 42, the embodiments are not limited thereto; the first screen 41 and the second screen 42 may contain at least either the ions 70 or the widgets 71, for example.

The smartphone 1 can switch display from the first screen 41 to the second screen 42 when a certain condition is satisfied. The certain condition includes a condition for determining which of the first screen 41 and the second screen 42 is displayed. The certain condition includes a condition on the ambient illuminance of the device, a condition on the position of the device, a condition on remaining battery life, and a condition on the setting of the brightness of the device and brightness outside the device, for example.

The condition on the ambient illuminance of the device includes a threshold of the ambient brightness of the device, for example. In this case, the smartphone 1 determines whether the brightness is brighter than the threshold based on the detection result of the illuminance sensor 4. The condition on the position of the device includes a position, an area, and the like for determining whether the position is an outdoor position, for example. In this case, the smartphone 1 determines whether the position is an outdoor position based on the position of the device acquired by the GPS receiver, the communication unit 6, and the like. The condition on remaining battery life includes a threshold of remaining battery life for switching to the second display 2B, which requires lower power consumption than the first display 2A, for example. In this case, the smartphone 1 determines whether the remaining battery life of the device is less than the threshold. The condition on the setting of the brightness of the device and brightness outside the device includes a threshold of a difference between the set brightness of the first display 2A and the brightness outside the device, for example. When the setting of the first display 2A is set to be darker, and, for example, when the smartphone 1 is used outdoor, the first display 2A may be difficult to be viewed owing to external light, ambient light, and the like. In this case, the smartphone 1 determines whether the difference between the set brightness of the first display 2A and the brightness outside the device is larger than the threshold based on the detection result of the illuminance sensor 4.

When the certain condition is satisfied, the smartphone 1 causes the second display 2B to display the second screen 42. The smartphone 1 controls the second display 2B such that a transparent part of the second screen 42 is the transmissive state ST1 and that a reflecting part thereof is the reflective state ST2, for example. The smartphone 1 causes the user to visually recognize the transparent part of the second screen 42 with the color of the first display 2A on the back thereof. The smartphone 1 causes the user to visually recognize the reflecting part of the second screen 42 with the color of the opaque second display 2B. Consequently, the smartphone 1 can cause the user to visually recognize the second screen 42 through the reflection and disturbance of external light or the like in the part of the reflective state ST2 of the second display 2B.

When having the first display 2A and the second display 2B, the smartphone 1 displays the second screen 42 on the second display 2B, which is easy to be viewed under bright external light and can thereby improve visibility. The smartphone 1 includes a polymer network liquid crystal display as the second display 2B and can thereby improve external light visibility and reduce power consumption by the second display 2B. The smartphone 1 makes the ratio of the reflective state ST2 with no voltage applied larger than the ratio of the transmissive state ST1 in the second screen 42 and can thereby reduce the power consumption by the second display 2B. The second screen 42 makes characters and a frame transparent and makes the other part opaque, for example, and can thereby make the ratio of the reflective state ST2 in the second display 2B larger than the ratio of the transmissive state ST1. When displaying the second screen 42 on the second display 2B, the smartphone 1 makes the first display 2A hidden and can thereby reduce power consumption by the first display 2A. Consequently, the smartphone 1 can lengthen the life of the battery of the device.

Although embodiments describe the case in which the smartphone 1 makes the characters, the frame, and the like of the second screen 42 transparent, the embodiments are not limited thereto; the smartphone 1 may reflect the characters, the frame, and the like of the second screen 42, for example.

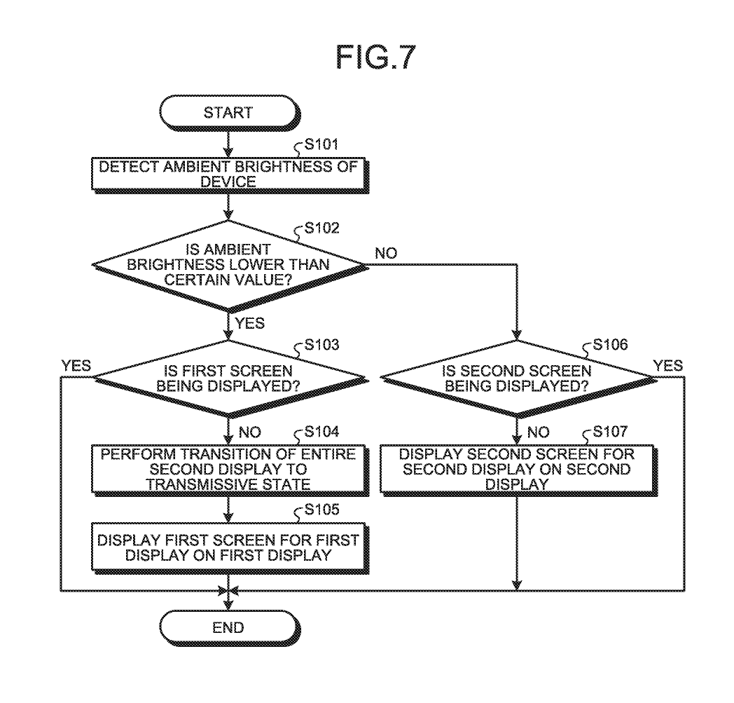

FIG. 7 is a flowchart of an exemplary processing procedure of display control by the smartphone 1 according to embodiments. The processing procedure illustrated in FIG. 7 is performed by executing the control program 9A by the controller 10. The processing procedure illustrated in FIG. 7 is repeatedly executed by the controller 10.

As illustrated in FIG. 7, the controller 10 of the smartphone 1 detects the ambient brightness of the device by the illuminance sensor 4 (Step S101). The controller 10 determines whether the ambient brightness is lower than a certain value (Step S102). If determining that the ambient brightness is lower than the certain value (Yes at Step S102), the controller 10 advances the processing to Step S103.

The controller 10 determines whether the first screen 41 is being displayed (Step S103). When the first display 2A is caused to display the first screen 41, the controller 10 determines that the first screen 41 is being displayed, for example. If the controller 10 determines that the first screen 41 is being displayed (Yes at Step S103), the controller 10 ends the processing procedure illustrated in FIG. 7. If determining that the first screen 41 is not being displayed (No at Step S103), the controller 10 advances the processing to Step S104.

The controller 10 performs transition of the entire second display 2B to the transmissive state ST1 (Step S104). The controller 10 causes the first display 2A to display the first screen 41 for the first display 2A (Step S105). Upon causing the first display 2A to display the first screen 41, the controller 10 ends the processing procedure illustrated in FIG. 7.

If determining that the ambient brightness is not lower than the certain value (No at Step S102), the controller 10 advances the processing to Step S106 because the ambient brightness is the certain value or higher in that case. The controller 10 determines whether the second screen 42 is being displayed (Step S106). When the second display 2B is caused to display the second screen 42, the controller 10 determines that the second screen 42 is being displayed, for example. If determining that the second screen 42 is being displayed (Yes at Step S106), the controller 10 ends the processing illustrated in FIG. 7.

If determining that the second screen 42 is not being displayed (No at Step S106), the controller 10 advances the processing to Step S107. The controller 10 causes the second display 2B to display the second screen 42 for the second display 2B (Step S107). The controller 10 causes the second display 2B to display the second screen 42 such that the transparent part of the second screen 42 is the transmissive state ST1 and that the reflecting part of the second screen 42 is the reflective state ST2, for example. Upon causing the second display 2B to display the second screen 42, the controller 10 ends the processing procedure illustrated in FIG. 7.

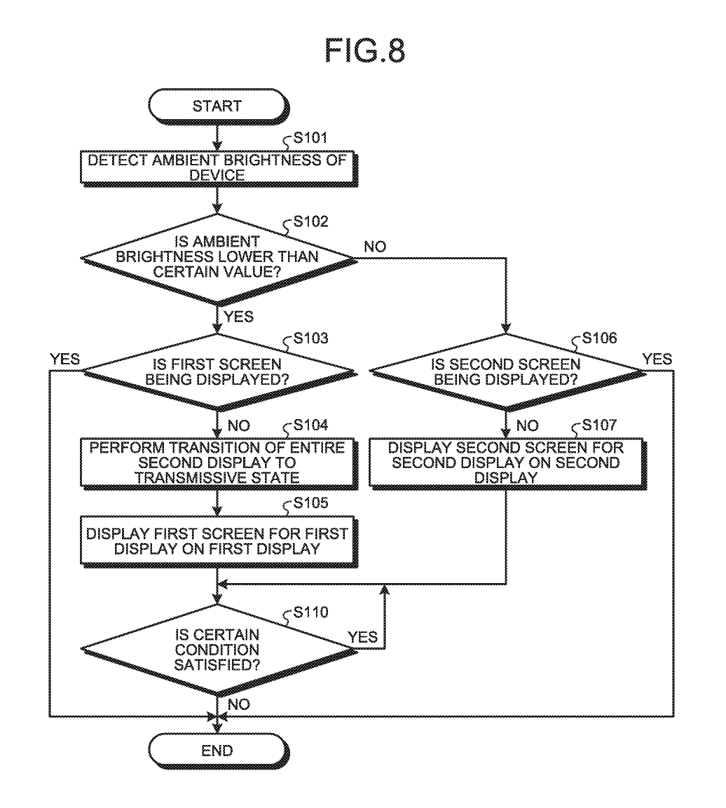

FIG. 8 is a flowchart of another exemplary processing procedure of the display control by the smartphone 1 according to embodiments. The processing procedure illustrated in FIG. 8 is performed by executing the control program 9A by the controller 10. The processing procedure illustrated in FIG. 8 is repeatedly executed by the controller 10.

In the example illustrated in FIG. 8, the processing from Step S101 to Step S107 is the same as the processing from Step S101 to Step S107 illustrated in FIG. 7, and only different parts are described with the descriptions of the same parts omitted.

Upon ending the processing at Step S105 or Step S107, the controller 10 proceeds to Step S110. The controller 10 determines whether a certain condition is satisfied (Step S110). The certain condition includes a condition for prohibiting switching to the first screen 41 or the second screen 42. The certain condition includes a condition for determining whether a certain time has elapsed from switching to the first screen 41 or the second screen 42, a condition for determining whether an operation by a user is continuing, and a condition for determining whether an application is being operated, for example. If determining that the certain condition is satisfied (Yes at Step S110), the controller 10 repeats the processing at Step S110, thereby prohibiting switching to the first screen 41 or the second screen 42. If determining that the certain condition is not satisfied (No at Step S110), the controller 10 ends the processing procedure illustrated in FIG. 8.

As illustrated in FIG. 8, when display is switched to the first screen 41 or the second screen 42, the smartphone 1 does not determine a change in the ambient brightness while the certain condition is satisfied. Consequently, the smartphone 1 can maintain the display of the screen being displayed even when the ambient brightness changes while the certain condition is satisfied after switching to the first screen 41 or the second screen 42 in accordance with the change in the ambient brightness. The smartphone 1 can prevent the screen from frequently switching in accordance with a change in brightness and can thus improve convenience.

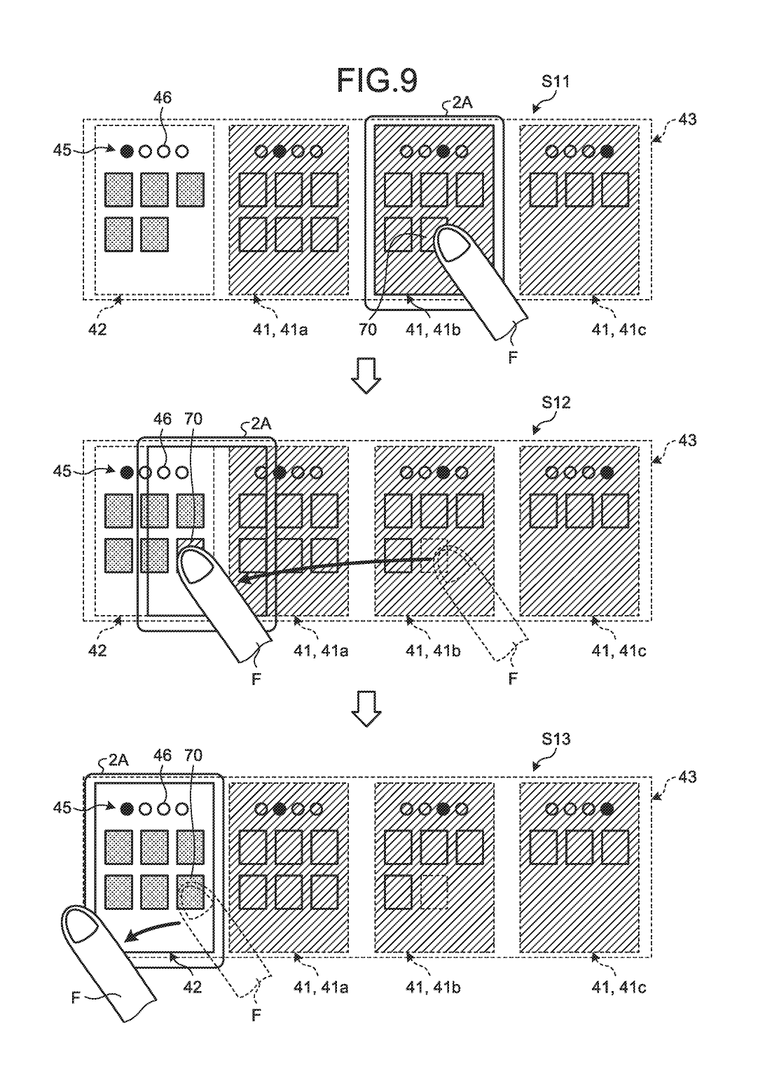

FIG. 9 is a diagram of an example of editing control on the first screen 41 and the second screen 42 by the smartphone 1 according to embodiments. As illustrated in FIG. 9, the smartphone 1 can display a third screen 43 containing the first screen 41 and the second screen 42 on the first display 2A in accordance with a certain operation. The third screen 43 contains a plurality of first screens 41. The third screen 43 contains a launcher screen. The launcher screen contains a home screen, an application screen, and the like. The launcher screen is a screen specialized in the execution of the applications.

The third screen 43 contains a screen that can move icons, widgets, and the like from one to the other of the first screen 41 and the second screen 42. The smartphone 1 can display the third screen 43 on the first display 2A such that each of the first screens 41 and the second screen 42 can switch to each other.

The smartphone 1 can display an indicator (locator) 45 on the first screens 41 and the second screen 42 of the third screen 43. The indicator 45 contains one or a plurality of symbols 46. The indicator 45 indicates the position of the first screen 41 or the second screen 42 being currently displayed. The symbol 46 corresponding to the screen being currently displayed is displayed in a mode different from those of the symbols 46 corresponding to the other screens.

In the example illustrated in FIG. 9, the smartphone 1 can display the third screen 43 having three first screens 41a, 41b, and 41c and one second screen 42. In this case, the smartphone 1 displays four symbols 46 of the indicator 45. This indicates that the third screen 43 has four screens. The four symbols 46 are arranged in a row from the left side of the screen toward the right side thereof. In the following, the first screens 41a, 41b, and 41c may be collectively referred to as the first screen 41 without specifying a screen among the screens.

At Step S11 in FIG. 9, the smartphone 1 displays the first screen 41b of the third screen 43 on the first display 2A in accordance with a certain operation. In the first screen 41b, the third symbol 46 from the left end is displayed in a mode different from those of the other symbols 46. This case indicates that the smartphone 1 displays the third screen from the left end of the third screen 43 on the first display 2A.

At Step S11, the user drags an icon 70 to be moved to another screen with a finger F. “Dragging” is a gesture that performs swiping with an area in which a movable object is displayed as a starting point.

The smartphone 1 detects a gesture of dragging on the icon 70, and when the icon 70 reaches the left end or the right end of the first display 2A, the smartphone 1 scrolls the screen being displayed to display an adjacent screen on the first display 2A. At Step S12, the user drags the icon 70 with the finger F from the first screen 41b to the second screen 42 located two screens away to the left. In the example illustrated at Step S12, the smartphone 1 detects that the icon 70 has been dragged from the first screen 41b to the second screen 42 located two screens away to the left. The smartphone 1 successively scrolls from the first screen 41b displayed on the first display 2A to the first screen 41a and the second screen 42.

At Step S13, the user drops the icon 70 dragged with the finger F at the scrolled second screen 42. “Dropping” is a gesture to release the icon 70 being dragged at a targeted position. Upon detecting the gesture to drop the icon 70 at the second screen 42, the smartphone 1 changes the display mode of the icon 70 and adds the icon 70 to the second screen 42. The smartphone 1 changes the icon 70 displayed in a mode for the first screen 41 to the icon 70 in a mode for the second screen 42, for example. Assume that the icon 70 in the first screen 41 is in a color mode, whereas the icon 70 in the second screen 42 is in a monochrome mode, for example. In this case, at Step S13, the smartphone 1 changes the mode of the icon 70 from the color mode to the monochrome mode. Upon adding the icon 70 to a destination screen, the smartphone 1 deletes the icon 70 from a source screen. In the example illustrated at Step S13, the smartphone 1 adds the icon 70 with the mode changed to the second screen 42 and then deletes the icon 70 from the first screen 41b as the source screen.

The smartphone 1 can move the icon 70 in the first screen 41 for the first display 2A to the second screen 42 for the second display 2B using the third screen 43. Consequently, the smartphone 1 can improve operability about the move of the icon 70 between the first screen 41 and the second screen 42. When moving the icon 70 in the first screen 41 to the second screen 42 by the third screen 43, the smartphone 1 can change the mode of the icon 70 to the mode of the destination screen and add the icon 70 to the destination screen. Consequently, the smartphone 1 can move the icon 70 between the screens in which the modes of the icon 70 are different from each other and can thus improve convenience.

Although the example illustrated in FIG. 9 describes the case in which the smartphone 1 moves the icon 70 in the first screen 41 to the second screen 42 using the third screen 43, the embodiments are not limited thereto. The smartphone 1 can move the icon 70 in the second screen 42 to the first screen 41 using the third screen 43, for example. In this case, the smartphone 1 can change the mode of the icon 70 to the mode of the icon 70 in the first screen 41 and add the icon 70 with the mode changed to the first screen 41.

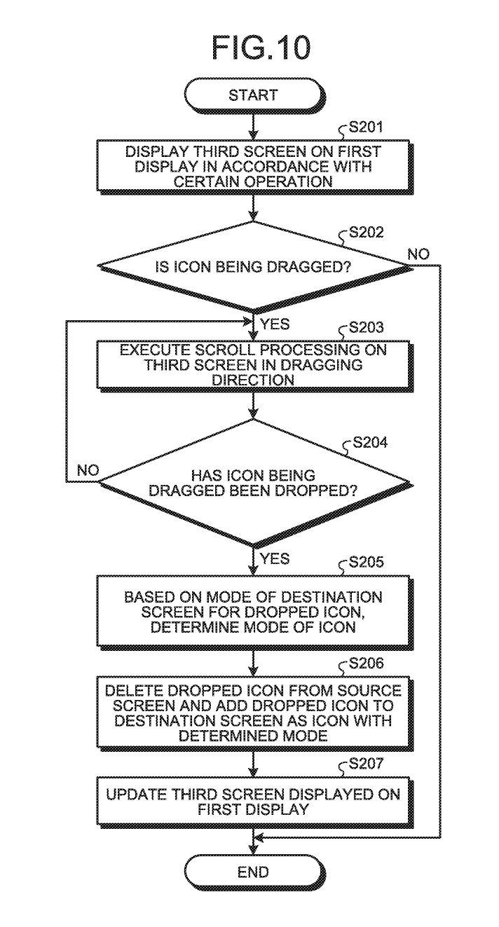

FIG. 10 is a flowchart of an exemplary processing procedure of the display control by the smartphone 1 according to embodiments. The processing procedure illustrated in FIG. 10 is performed by executing the control program 9A by the controller 10. The processing procedure illustrated in FIG. 10 includes a processing procedure for moving the icon 70 to another screen using the third screen 43. The processing procedure illustrated in FIG. 10 is repeatedly executed by the controller 10.

As illustrated in FIG. 10, the controller 10 of the smartphone 1 causes the first display 2A to display the third screen 43 in accordance with a certain operation (Step S201). The smartphone 1 causes the first display 2A to display one first screen 41 of the third screen 43 together with the indicator 45, for example. Upon causing the first display 2A to display the third screen 43, the controller 10 proceeds to Step S202.

The controller 10 determines whether the icon 70 is being dragged (Step S202). When a gesture of dragging on the icon 70 displayed on the first display 2A is detected, the controller 10 determines that the icon 70 is being dragged, based on the detection result of the touch screen 2C, for example. If determining that the icon 70 is not being dragged (No at Step S202), the controller 10 ends the processing procedure illustrated in FIG. 10.

If determining that the icon 70 is being dragged (Yes at Step S202), the controller 10 advances the processing to Step S203. The controller 10 executes scroll processing on the third screen 43 in a dragging direction (Step S203). The scroll processing includes display control processing to scroll from the screen displayed on the third screen 43 to an adjacent screen when the gesture of dragging on the icon 70 is continuing, for example. Upon executing the scroll processing, the controller 10 proceeds to Step S204.

The controller 10 determines whether the icon 70 being dragged has been dropped (Step S204). When a gesture to release the icon 70 being dragged is detected, the controller 10 determines that the icon 70 being dragged has been dropped, based on the detection result of the touch screen 2C, for example. If determining that the icon 70 being dragged has not been dropped (No at Step S204), the controller 10 returns the processing to Step S203, which has been already described. If determining that the icon 70 being dragged has been dropped (Yes at Step S204), the controller 10 advances the processing to Step S205.

Based on the mode of the destination screen for the dropped icon 70, the controller 10 determines the mode of the icon 70 (Step S205). When the source screen and the destination screen have different modes, for example, the controller 10 changes the mode of the dropped icon 70 to the mode of the icon 70 of the destination screen. When the source screen and the destination screen have the same mode, for example, the controller 10 does not change the mode of the dropped icon 70. Upon determining the mode of the icon 70, the controller 10 proceeds to Step S206.

The controller 10 deletes the dropped icon 70 from the source screen and adds the dropped icon 70 to the destination screen as the icon 70 with the determined mode (Step S206). Upon adding the dropped icon 70 to the destination screen, the controller 10 proceeds to Step S207.

The controller 10 updates the third screen 43 displayed on the first display 2A (Step S207). Upon causing the first display 2A to display a screen containing the moved icon 70, the controller 10 ends the processing procedure illustrated in FIG. 10.

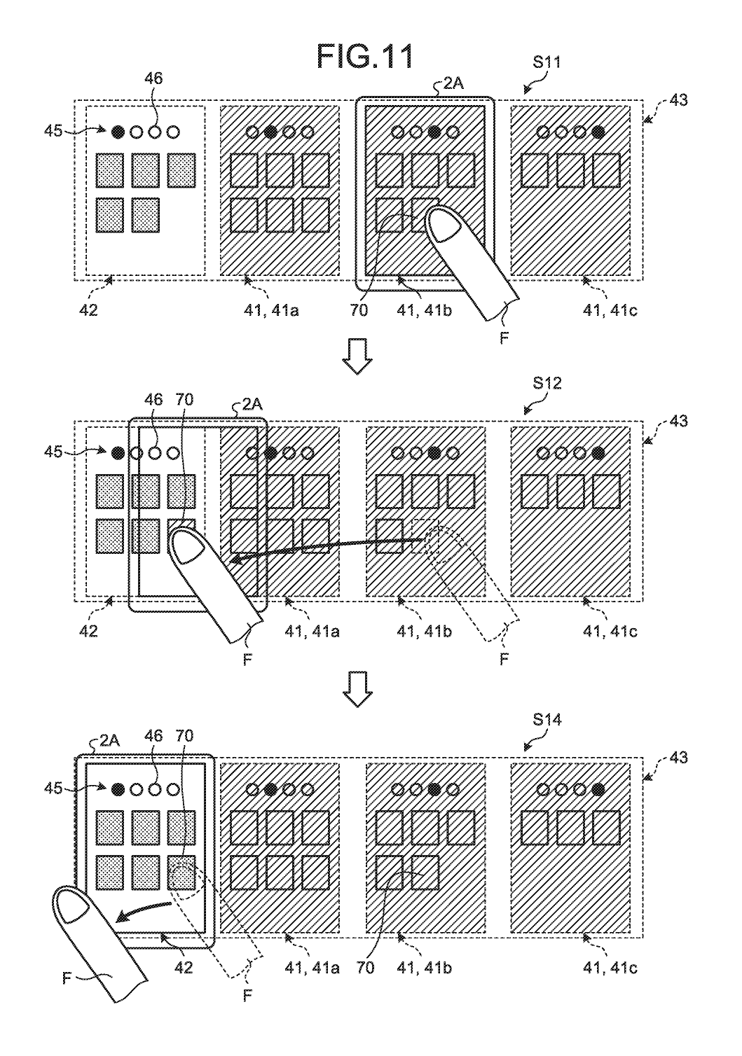

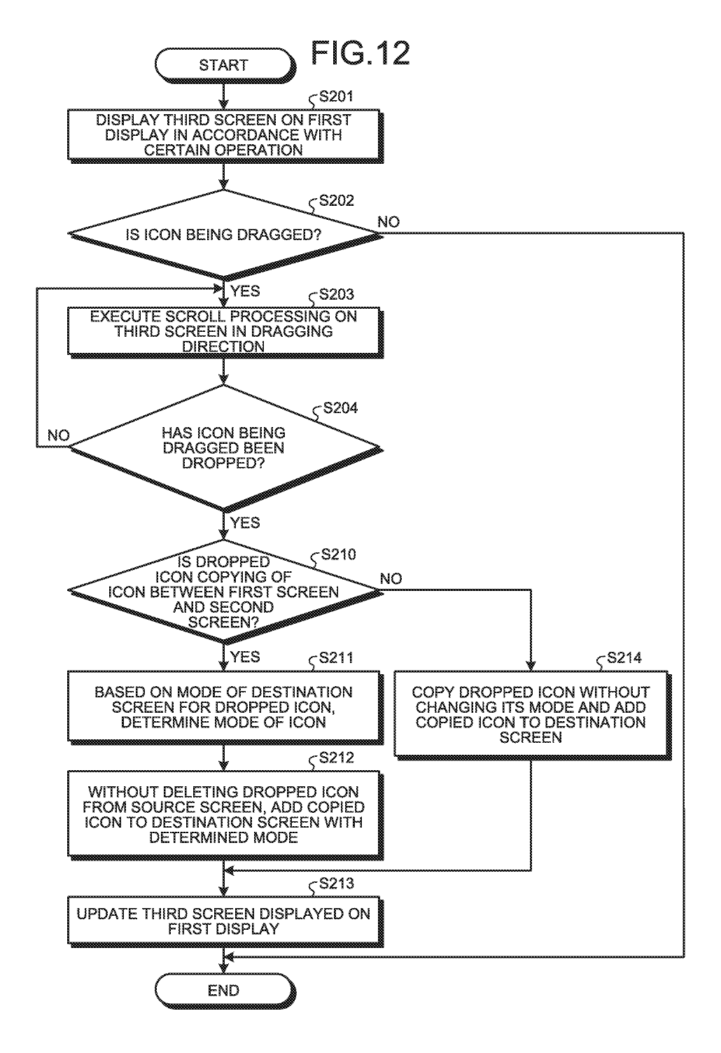

FIG. 11 is a diagram of another example of the editing control on the first screen and the second screen by the smartphone 1 according to embodiments. As illustrated in FIG. 11, the smartphone 1 can display the third screen 43 containing the first screen 41 and the second screen 42 on the first display 2A in accordance with a certain operation. In the example illustrated in FIG. 11, the processing from Step S11 to Step S12 is the same as the processing from Step S11 to Step S12 illustrated in FIG. 9, and only different parts are described with the descriptions of the same parts omitted.

At Step S12, the smartphone 1 detects a gesture of dragging on the icon 70, and when the icon 70 reaches the left end or the right end of the first display 2A, the smartphone 1 scrolls the screen being displayed to display an adjacent screen on the first display 2A. At Step S12, the user drags the icon 70 with the finger F from the first screen 41b to the second screen 42 located two screens away to the left. In the example illustrated at Step S12, the smartphone 1 detects that the icon 70 has been dragged from the first screen 41b to the second screen 42 located two screens away to the left and scrolls from the first screen 41a displayed on the first display 2A to the second screen 42.

At Step S14, the user drops the icon 70 dragged with the finger F at the scrolled second screen 42. Upon detecting a gesture to drop the icon 70 at the second screen 42, the smartphone 1 copies the icon 70. The smartphone 1 changes the display mode of the copied icon 70 and adds the icon 70 to the second screen 42. The smartphone 1 changes the icon 70 displayed in the mode for the first screen 41 to the icon 70 in the mode for the second screen 42. Assume that the icon 70 in the first screen 41 is the color mode, whereas the icon 70 in the second screen 42 is the monochrome mode, for example. In this case, at Step S14, the smartphone 1 changes the icon 70 from the color mode to the monochrome mode. In the example illustrated in FIG. 11, the smartphone 1 adds the copied icon 70 to the destination screen and does not delete the dragged icon 70 from the source screen.

The smartphone 1 can copy the icon 70 in the first screen 41 for the first display 2A to the second screen 42 for the second display 2B using the third screen 43. Consequently, the smartphone 1 can improve operability about the copying of the icon 70 between the first screen 41 and the second screen 42. When copying the icon 70 in the first screen 41 to the second screen 42 by the third screen 43, the smartphone 1 can change the mode of the icon 70 to the mode of the destination screen and copy the icon 70 to the destination screen. Consequently, the smartphone 1 can copy the icon 70 between the screens in which the modes of the icon 70 are different from each other and can thus improve convenience.

FIG. 12 is a flowchart of another exemplary processing procedure of the display control by the smartphone 1 according to embodiments. The processing procedure illustrated in FIG. 12 is performed by executing the control program 9A by the controller 10. The processing procedure illustrated in FIG. 12 includes a processing procedure for copying the icon 70 to another screen using the third screen 43. The processing procedure illustrated in FIG. 12 is repeatedly executed by the controller 10.

In the example illustrated in FIG. 12, the processing from Step S201 to Step S204 is the same as the processing from Step S201 to Step S204 illustrated in FIG. 10, and only different parts are described with the descriptions of the same parts omitted.

If determining that the icon 70 being dragged has been dropped at Step S204 (Yes at Step S204), the controller 10 advances the processing to Step S210. The controller 10 determines whether the dropping is the copying of the icon 70 between the first screen 41 and the second screen 42 (Step S210). The controller 10 determines whether the dropping is the copying of the icon 70 from the first screen 41 to the second screen 42 or from the second screen 42 to the first screen 41 based on the starting position of the dragging and the position of the dropping in the third screen 43, for example.

If determining that the dropping is the copying of the icon 70 between the first screen 41 and the second screen 42 (Yes at Step S210), the controller 10 advances the processing to Step S211. The controller 10 determines the mode of the icon 70 based on the mode of the destination screen for the dropped icon 70 (Step S211). When the dropping is the copying of the icon 70 from the first screen 41 to the second screen 42, for example, the controller 10 determines the mode of the icon 70 in the second screen 42 as the mode of the icon 70 to be copied. When the dropping is the copying of the icon 70 from the second screen 42 to the first screen 41, for example, the controller 10 determines the mode of the icon 70 in the first screen 41 as the mode of the icon 70 to be copied. Upon determining the mode of the icon 70 to be copied, the controller 10 proceeds to Step S212.

The controller 10 does not delete the dropped icon 70 from the source screen and adds the copied icon 70 to the destination screen with the determined mode (Step S212). Upon adding the dropped icon 70 to the destination screen, the controller 10 proceeds to Step S213.

The controller 10 updates the third screen 43 displayed on the first display 2A (Step S213). Upon causing the first display 2A to display a screen containing the moved icon 70, the controller 10 ends the processing procedure illustrated in FIG. 12.

If determining that the dropping is not the copying of the icon 70 between the first screen 41 and the second screen 42 (No at Step S210), the controller 10 advances the processing to Step S214. The controller 10 copies the dropped icon 70 without changing its mode and adds the copied icon 70 to the destination screen (Step S214). Upon adding the dropped icon 70 to the destination screen, the controller 10 proceeds to Step S213, which has been already described. Upon updating the third screen displayed on the first display 2A, the controller 10 ends the processing procedure illustrated in FIG. 12.

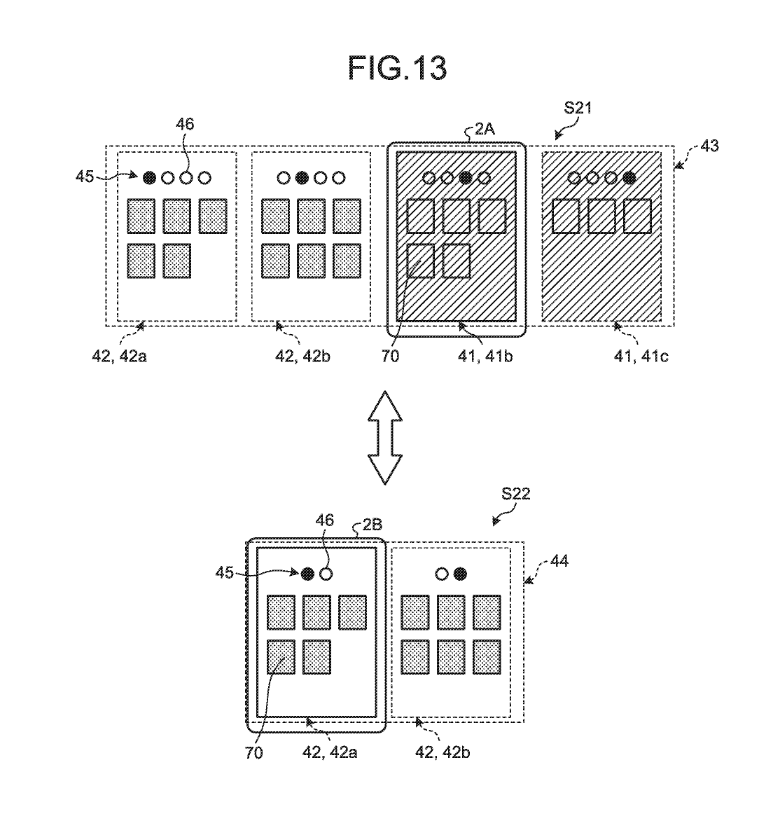

FIG. 13 is a diagram of an example of display control on the third screen 43 and a fourth screen 44 by the smartphone 1 according to embodiments. In the example illustrated in FIG. 13, only parts different from those of FIG. 9 are described with the descriptions of the same parts omitted.

As illustrated in FIG. 13, the smartphone 1 displays the third screen 43 on the first display 2A in response to a request for displaying the third screen 43. The request for displaying the third screen 43 includes a request occurring when a certain operation is detected while the first screen 41 is being displayed on the first display 2A, for example. The third screen 43 contains the first screen 41 and the second screen 42. At Step S21 in FIG. 13, the third screen 43 contains two first screens 41b and 41c and two second screens 42a and 42b. The smartphone 1 displays the first screen 41b of the third screen 43 on the first display 2A. Upon detecting a gesture of dragging, swiping, and the like via the touch screen 2C, the smartphone 1 can scroll the third screen 43 to display the third screen 43 on the first display 2A. In this case, the smartphone 1 makes the entire second display area 300 of the second display 2B the transmissive state ST1 to make the second display 2B transparent.

The smartphone 1 displays the fourth screen 44 on the second display 2B in response to a request for displaying the fourth screen 44. The request for displaying the fourth screen 44 includes a request occurring when a certain operation is detected while the second screen 42 is being displayed on the second display 2B, for example. The fourth screen 44 contains the second screen 42. The fourth screen 44 does not contain the first screen 41. The second screen 42 of the fourth screen 44 has the same configuration as that of the second screen 42 of the third screen 43. The second screen 42 of the fourth screen 44 corresponds to the second screen 42 of the third screen 43 represented by a transparent part and a reflecting part. The fourth screen 44 contains a launcher screen for the second display 2B. The fourth screen 44 contains a screen that can move icons, widgets, and the like from one to another of a plurality of second screens 42.

In the example illustrated at Step S22, the fourth screen 44 contains the two second screens 42a and 42b. The smartphone 1 displays the second screen 42a of the fourth screen 44 on the second display 2B. The smartphone 1 displays the transparent part of the second screen 42a as the transmissive state ST1 and displays the reflecting part of the second screen 42a as the reflective state ST2 on the second display 2B. In this case, the smartphone 1 can hide the first display 2A behind the second display 2B by the part of the reflective state ST2 of the second display 2B.

The smartphone 1 can display the indicator (locator) 45 on the second screen 42 of the fourth screen 44. The indicator 45 contains one or a plurality of symbols 46. The indicator 45 indicates the position of the second screen 42 being currently displayed. The symbol 46 corresponding to the screen being currently displayed is displayed in a mode different from those of the symbols 46 corresponding to the other screens.

In the example illustrated at Step S22, the smartphone 1 can display the fourth screen 44 having the two second screens 42a and 42b on the second display 2B. In this case, the smartphone 1 displays two symbols 46 of the indicator 45. This indicates that the fourth screen 44 has the two second screens 42a and 42b. The two symbols 46 are arranged in a row from the left side of the screen toward the right side thereof. In the following, the second screens 42a and 42 may be collectively referred to as the second screen 42 without specifying a screen among the screen.

Upon detecting a gesture of dragging, swiping, and the like via the touch screen 2C, the smartphone 1 can scroll the fourth screen 44 to display the fourth screen 44 on the second display 2B. When the fourth screen 44 has only one second screen 42, for example, the smartphone 1 may display only the second screen 42 as the fourth screen 44 on the second display 2B.

The smartphone 1 displays the fourth screen 44 on the second display 2B and can thereby reduce power consumption compared with a case in which the first display 2A is driven. The smartphone 1 can display the fourth screen 44 on the second display 2B that reflects and disturbs external light when the surrounding of the device is bright, for example, and can thus improve visibility and convenience.

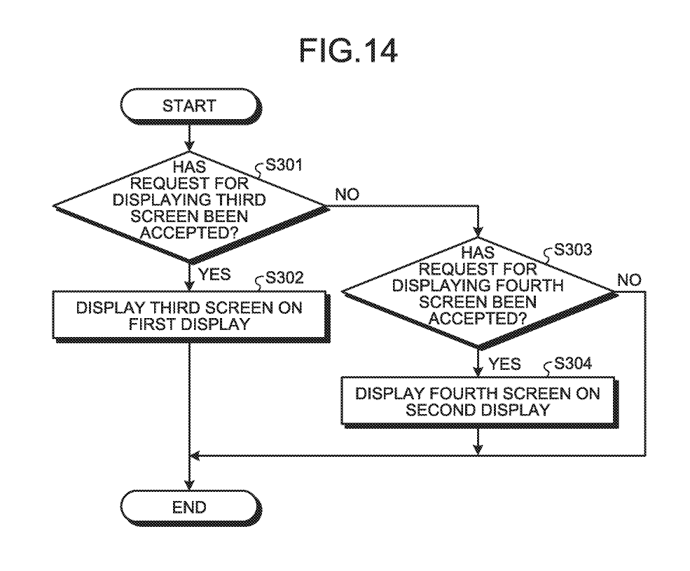

FIG. 14 is a flowchart of another exemplary processing procedure of the display control by the smartphone 1 according to embodiments. The processing procedure illustrated in FIG. 14 is performed by executing the control program 9A by the controller 10. The processing procedure illustrated in FIG. 14 is repeatedly executed by the controller 10.

As illustrated in FIG. 14, the controller 10 of the smartphone 1 determines whether a request for displaying the third screen 43 has been accepted via the touch screen 2C or the button 3 (Step S301). If determining that the request for displaying the third screen 43 has been accepted (Yes at Step S301), the controller 10 advances the processing to Step S302.

The controller 10 causes the first display 2A to display the third screen 43 (Step S302). Upon causing the first display 2A to display the third screen 43, the controller 10 ends the processing procedure illustrated in FIG. 14.

If determining that the request for displaying the third screen 43 has not been accepted (No at Step S301), the controller 10 advances the processing to Step S303. The controller 10 determines whether a request for displaying the fourth screen 44 has been accepted via the touch screen 2C or the button 3 (Step S303). If determining that the request for displaying the fourth screen 44 has not been accepted (No at Step S303), the controller 10 ends the processing procedure illustrated in FIG. 14.

If determining that the request for displaying the fourth screen 44 has been accepted (Yes at Step S303), the controller 10 advances the processing to Step S304. The controller 10 causes the second display 2B to display the fourth screen 44 (Step S304). The controller 10 causes the second display 2B to display the fourth screen 44 such that the transparent part of the fourth screen 44 is the transmissive state ST1 and that the reflecting part of the fourth screen 44 is the reflective state ST2, for example. Upon causing the second display 2B to display the fourth screen 44, the controller 10 ends the processing procedure illustrated in FIG. 14.

Embodiments disclosed by the present application can be modified without departing from the gist and the scope of the disclosure. Further, embodiments disclosed by the present application can be combined with each other as appropriate. Embodiments may be modified as follows, for example.

The computer programs illustrated in FIG. 5 may be divided into a plurality of modules or combined with other computer programs, for example.

Although embodiments describe the case in which when causing the first display 2A to display the first screen 41, the smartphone 1 makes the entire second display 2B the transmissive state ST1, the embodiments are not limited thereto; the smartphone 1 may make only partial area of the second display 2B the transmissive state ST1 to enable the first screen 41 displayed on the first display 2A to be partially visually recognized, for example. The smartphone 1 may hide part of the first screen 41 displayed on the first display 2A at the part of the reflective state ST2 of the second display 2B.

Although embodiments describe the case in which the smartphone 1 includes the substantially rectangular second display 2B, the embodiments are not limited thereto; the smartphone 1 may include the second display 2B having a polygonal, elliptic, or star-like shape, for example. In this case, the smartphone 1 can hide the first display 2A by the second display 2B having a unique shape.

Although embodiments describe the case in which the smartphone 1 has the touch screen 2C substantially the same in size as the first display 2A, the embodiments are not limited thereto; the smartphone 1 may have the touch screen 2C substantially the same in size as the second display 2B, for example.

Although embodiments describe the case in which the smartphone 1 stacks one second display 2B on the display face side of the first display 2A, the embodiments are not limited thereto; the smartphone 1 may stack a plurality of second displays 2B on the display face side of the first display 2A, for example.

Although embodiments describe the case in which the first screen 41 and the second screen 42 are screens on which icons, widgets, and the like are arranged as an example, the embodiments are not limited thereto; the first screen 41 and the second screen 42 may be any screen that can be displayed by mobile electronic devices.

Although the case in which the first screen 41 and the second screen 42 are different from each other in modes (size, design, and the like) as illustrated in FIG. 6 has been described as an example, the embodiments are not limited thereto; the first screen 41 and the second screen 42 may be the same image. The first screen 41 and the second screen 42 may be the same image except that they are different from each other about being displayed in color or being displayed in monochrome, for example.

Although embodiments describe the case in which the smartphone 1 causes the first display 2A to display the first screen 41 when the detected ambient brightness of the device is lower than the certain value and causes the second display 2B to display the second screen 42 when the detected ambient brightness of the device is the certain value or higher, the embodiments are not limited thereto; the smartphone 1 may cause the first display 2A to display the first screen 41 when the acquired position of the device is an indoor position and cause the second display 2B to display the second screen 42 when the acquired position of the device is an outdoor position. The smartphone 1 may cause the first display 2A to display the first screen 41 when the remaining battery life of the device is the threshold or longer and cause the second display 2B to display the second screen 42 when the remaining battery life of the device is shorter than the threshold. The smartphone 1 may cause the first display 2A to display the first screen 41 when the difference between the set brightness of the first display 2A and the brightness outside the device is smaller than the threshold and cause the second display 2B to display the second screen 42 when the difference between the set brightness of the first display 2A and the brightness outside the device is the threshold or larger.

Although embodiments describe the smartphone 1 as the example of the mobile electronic device, the mobile electronic device according to the accompanying claims is not limited to the smartphone 1. The mobile electronic device according to the accompanying claims may be an electronic device other than the smartphone 1. Examples of the electronic device include, but are not limited to, mobile phones, smart watches, portable personal computers, head mount displays, digital cameras, media players, electronic book readers, navigators, game machines, etc.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile electronic device, comprising:
a first display;
a second display that overlaps with the first display and configured to be switched between a transmissive state that passes incident light and a reflective state that reflects incident light; and
a controller configured to control display of a first screen for the first display and a second screen for the second display, wherein
the controller
switches at least part of the second display to the transmissive state to cause the first display to display the first screen, and
causes the second display to display the second screen in accordance with a condition.

2. The mobile electronic device according to claim 1, wherein the condition is at least one of a condition on ambient illuminance, a condition on a position of the device, a condition on remaining battery life, and a condition on brightness of a screen of the device and brightness of outside of the device.

3. The mobile electronic device according to claim 1, wherein the controller causes the first display or the second display to display a third screen containing the first screen and the second screen.

4. The mobile electronic device according to claim 3, wherein
the third screen is a screen capable of moving an icon from one to another of the first screen and the second screen, and
if the icon has been moved from the one to the other of the first screen and the second screen in the third screen, the controller changes a mode of the icon.

5. The mobile electronic device according to claim 3, wherein
the third screen is a screen capable of dragging an icon from one to another of the first screen and the second screen, and
if the icon has been dragged from the one to the other of the first screen and the second screen, and the icon has been dropped in the other in the third screen, the controller changes a mode of the icon.

6. The mobile electronic device according to claim 3, wherein
the third screen is a screen capable of dragging an icon from one to another of the first screen and the second screen, and
if the icon has been dragged from the one to the other of the first screen and the second screen, and the icon has been dropped in the other in the third screen, the controller receives a selection whether the icon is moved or copied.

7. The mobile electronic device according to claim 1, wherein the controller
causes the first display to display a third screen containing the first screen and the second screen and
causes the second display to display a fourth screen that contains the second screen and does not contain the first screen.

8. The mobile electronic device according to claim 1, further comprising a sensor configured to detect ambient brightness of the device, wherein the controller
causes the first display to display the first screen if the detected ambient brightness is lower than a certain value and
causes the second display to display the second screen if the detected ambient brightness is the certain value or higher.

9. The mobile electronic device according to claim 8, wherein the controller
does not cause the second display to display the second screen even when the ambient brightness becomes the certain value or higher if a certain condition is satisfied while the first display is being caused to display the first screen and
does not cause the first display to display the first screen even when the ambient brightness becomes lower than the certain value if the certain condition is satisfied while the second display is being caused to display the second screen.

10. A control method executed by a mobile electronic device that comprises a first display and a second display that overlaps with the first display and configured to be switched between a transmissive state that passes incident light and a reflective state that reflects incident light, the control method comprising steps of:
switching at least part of the second display to the transmissive state to cause the first display to display a first screen for the first display, and
causing the second display to display a second screen for the second display in accordance with a condition.

11. A non-transitory computer readable recording medium storing therein a control program causing a mobile electronic device that comprises a first display and a second display that overlaps with the first display and configured to be switched between a transmissive state that passes incident light and a reflective state that reflects incident light to execute steps of:
switching at least part of the second display to the transmissive state to cause the first display to display a first screen for the first display, and
causing the second display to display a second screen for the second display in accordance with a condition.
